(19) United States
(12) Patent Application Publication
(10) Pub. No.: US 2009/0208310 A1
(43) Pub. Date: Aug. 20, 2009

(54) Anchoring device

(75) Inventor: Kazuichi Ikuta, Higashiosaka (JP)

Correspondence Address: WENDEROTH, LIND & PONACK, L.L.P., 1030 15th Street, N.W.,, Suite 400 East, Washington, DC, 20005-1503, US

(73) Assignee: Wakai & Co.,Ltd.

(21) Appl. No.: 12/320,825

(22) Filed: Feb. 5, 2009

(30) Foreign Application Priority Data
Feb. 14, 2008 (JP) 2008-063334

(51) Int. Cl. F16B 13/04; F16B 37/00; F16B 13/10

(52) U.S. Cl. 411/344

(57) ABSTRACT

An anchoring device includes an insertion member having a trough-shaped trunk and a pocket provided at the front end of the trunk. A plate nut is inserted in the pocket and formed with a threaded hole at its portion protruding from the pocket. A seat member is fitted around the trunk. An engaging rib is formed on the inner surface of the seat member. A plurality of steps are formed on the outer surface of the trunk and arranged in the longitudinal direction of the trunk. When the seat member is moved toward the front end of the trunk, the engaging rib engages the respective steps one after another, thereby preventing the seat member from moving toward the rear end of the trunk. Any step nearer to the rear end of the trunk is smaller than any step nearer to the front end of the trunk.

### BACKGROUND OF THE INVENTION

This invention relates to an anchoring device for securing various members and instruments to the front side of a member of which the back is inaccessible by hand.

In order to fix various members and instruments to the surface of a wall in which a threaded hole cannot be formed, it is necessary to place a nut on the back of the wall.

But if the back of the wall is inaccessible by hand, it is necessary to use an anchoring device to place a nut on the back side of the wall by inserting the nut through the wall from its front side.

U.S. Pat. No. 4,079,655 discloses a conventional anchoring device which comprises a wing nut formed by pressing a thin metal plate, foldable arm members supporting the wing nut, and a bolt which is threadedly engageable with the nut. With the bolt threadedly engaged with the nut, the bolt is inserted through a hole formed in a wall member while folding the arms. When the arms come out of the hole into the back side of the wall, the arms spread. In this state, the bolt is threaded into the nut.

In order to solve various problems of this anchoring device, the inventor of this invention proposed a novel anchoring device in JP Patent 2750093. This anchoring device includes an insertion member comprising a trough-shaped trunk and a pocket connected to the front end of the trough-shaped trunk through bendable portions so as to extend at a predetermined angle relative to the longitudinal direction of the trunk. This anchoring device further includes a plate nut inserted in the pocket and formed with a threaded hole at its portion protruding from the pocket, and a seat member inserted on the trough-shaped trunk. Retaining means are provided on the radially inner surface of the seat member and on the radially outer surface of the trough-shaped trunk to prevent the seat member from being coming out of the trunk.

The anchoring device disclosed in JP Patent 2750093 has various advantages over existing anchoring devices. For example, this anchoring device makes it possible to more rigidly secure various objects to a wall, is simple in structure, and can be manufactured at a lower cost. But new problems have also been found in this anchoring device.

That is, when securing various members and instruments to a wall, the seat member is inseparably held in a predetermined position on the trough-shaped trunk according to the thickness of the wall. The retainer means provided on the radially outer surface of the trough-shaped trunk is a serration-shaped member comprising a plurality of steps. Especially if the wall is thin, the retainer means on the inner surface of the seat member comprises a single engaging rib, which engages the respective steps on the trunk one at a time as the seat member is advanced toward the front end of the trough-shaped trunk. When the seat member is advanced, the engaging rib on the inner surface of the seat member moves past the respective steps on the trunk by elastically deforming the steps. When the engaging rib repeatedly moves past the steps, the rib tends to become worn due to friction between the rib and the respective steps. Thus, by the time the engaging rib is moved to the predetermined position, the rib may be engaged with one of the ribs with a weak force and thus cannot sufficiently prevent the seat member from coming out of the trunk.

An object of this invention is therefore to provide an anchoring device which can reliably prevent the seat member from coming out of the trough-shaped trunk irrespective of the thickness of the wall member.

### SUMMARY OF THE INVENTION

In order to achieve this object, the present invention provides an anchoring device comprising an insertion member comprising a trough-shaped trunk having a longitudinal axis and first and second longitudinal ends, and a pocket provided at the first longitudinal end of the trough-shaped trunk through a bendable portion so as to form an angle relative to the longitudinal axis of the trough-shaped trunk, a plate nut inserted in the pocket and formed with a threaded hole at its portion protruding from the pocket, a seat member fitted around the trough-shaped trunk, and first and second retainer means provided on a radially outer surface of the trough-shaped trunk and a radially inner surface of the seat member, respectively, for keeping the seat member from coming off the trough-shaped trunk, the first retainer means comprising a plurality of steps arranged in the direction of the longitudinal axis of the trough-shaped trunk and having a serration-shaped longitudinal section, each of the steps comprising a surface facing the first longitudinal end and extending substantially perpendicular to the longitudinal axis of the trough-shaped trunk, and a surface facing the second longitudinal end and extending oblique to the longitudinal axis of the trough-shaped trunk, wherein any of the steps nearer to the second longitudinal end of the trough-shaped trunk is smaller than any of the steps nearer to the first longitudinal end of the trough-shaped trunk, whereby the second retainer means engages any of the steps nearer to the second longitudinal end with a smaller force.

From another aspect, the present invention provides an anchoring device comprising an insertion member comprising a trough-shaped trunk having a longitudinal axis and first and second longitudinal ends, and a pocket provided at the first longitudinal end of the trough-shaped trunk through a bendable portion so as to form an angle relative to the longitudinal axis of the trough-shaped trunk, a plate nut inserted in the pocket and formed with a threaded hole at its portion protruding from the pocket, a seat member fitted around the trough-shaped trunk, and first and second retainer means provided on a radially outer surface of the trough-shaped trunk and a radially inner surface of the seat member, respectively, for keeping the seat member from coming off the trough-shaped trunk, the first retainer means comprising a plurality of steps arranged in the direction of the longitudinal axis of the trough-shaped trunk and having a serration-shaped longitudinal section, each of the steps comprising a surface facing the first longitudinal end and extending substantially perpendicular to the longitudinal axis of the trough-shaped trunk, and a surface facing the second longitudinal end and extending oblique to the longitudinal axis of the trough-shaped trunk, wherein any of the steps nearer to the second longitudinal end of the trough-shaped trunk has a smaller height than any of the steps nearer to the first longitudinal end of the trough-shaped trunk, whereby the second retainer means engages any of the steps nearer to the second longitudinal end with a smaller force.

From still another aspect, the present invention provides an anchoring device comprising, an insertion member comprising a trough-shaped trunk having a longitudinal axis and first and second longitudinal ends, and a pocket provided at the first longitudinal end of the trough-shaped trunk through a bendable portion so as to form an angle relative to the longitudinal axis of the trough-shaped trunk, a plate nut inserted in the pocket and formed with a threaded hole at its portion protruding from the pocket, a seat member fitted around the trough-shaped trunk, and first and second retainer means provided on a radially outer surface of the trough-shaped trunk and a radially inner surface of the seat member, respectively, for keeping the seat member from coming off the trough-shaped trunk, the first retainer means comprising a plurality of steps arranged in the direction of the longitudinal axis of the trough-shaped trunk and having a serration-shaped longitudinal section, each of the steps comprising a surface facing the first longitudinal end and extending substantially perpendicular to the longitudinal axis of the trough-shaped trunk, and a surface facing the second longitudinal end and extending oblique to the longitudinal axis of the trough-shaped trunk, wherein any of the steps nearer to the second longitudinal end of the trough-shaped trunk has a smaller width than any of the steps nearer to the first longitudinal end of the trough-shaped trunk, whereby the second retainer means engages any of the steps nearer to the second longitudinal end with a smaller force.

With this arrangement, with the plate nut inserted in the pocket, the bendable portions are bent so that the pocket and the plate nut extend substantially parallel to the longitudinal direction of the trough-shaped trunk. In this state, the trough-shaped trunk is inserted into a hole of a wall member with the pocket first. When the plate nut and the pocket protrude from the hole into the back side of the wall member, the pocket returns to the original position under the elastic force of the bendable portions. In this state, the trough-shaped trunk is pulled back until the pocket and the plate nut abut the back of the wall member. Then the seat member, which is inserted on the trough-shaped trunk, is pushed forward into the hole of the wall member. While the seat member is being advanced, the retainer means formed on the radially inner surface of the seat member engage, one after another, the plurality of serration-shaped steps formed on the radially outer surface of the trough-shaped trunk as the retainer means. When the seat member abuts the wall member, the retainer means on the seat member engages one of the steps on the trunk, thereby keeping the seat member from coming out of the trough-shaped trunk. In this state, the portion of the trough-shaped trunk protruding from the seat member is removed by breaking it.

A bolt is then inserted through the seat member into the hole of the wall member so as to move along the inner surface of the trough-shaped trunk, and then threaded into the threaded hole of the plate nut, thereby securing an object placed against the front side of the wall member to the wall member.

According to the present invention, among the steps formed on the radially outer surface of the trough-shaped trunk, those nearer to the rear end of the trunk are smaller than those nearer to the front end of the trunk. Thus, when the seat member is pushed into the trough-shaped trunk, the retainer means formed on the radially inner surface of seat member is less like to become worn. Also, even if the retainer means on the seat member becomes worn when moved toward the front end of the trunk, since steps nearer to the front end of the trunk is larger than those nearer to the rear end, the retainer means on the seat member can reliably prevent separation of the seat member by engaging any of the steps. Also, because the retainer means on the radially inner surface of the seat member engages the retainer means formed on the radially outer surface of the trough-shaped trunk with a smaller force when the seat member begins to move, the seat member can be pushed toward the front end of the trunk with a fingertip with minimum resistance.

### BRIEF DESCRIPTION OF THE DRAWINGS

Other features and objects of the present invention will become apparent from the following description made with reference to the accompanying drawings, in which:

FIG. 1A shows an anchoring device according to the present invention, showing a state in which the anchoring device is being moved through a lateral hole of a wall member, which is shown in vertical section;

FIG. 1B is view similar to FIG. 1A, showing a state in which the anchoring device is mounted in the lateral hole of the wall member;

FIG. 2 is a enlarged view of a portion of FIG. 1B, showing the anchoring device in vertical section;

FIG. 3A is an enlarged plan view of a front end portion of an insertion member;

FIG. 3B is a sectional view taken along line III-III of FIG. 3A;

FIG. 4A is a front view of a seat member;

FIG. 4B is a sectional view taken along line IV-IV of FIG. 4A;

FIG. 5 is an exploded perspective view of a portion of the anchoring device;

FIG. 6 is a partial enlarged view of an anchoring device according to the present invention having steps of which those nearer to the rear end of the trunk have smaller heights than those nearer to the front end of the trunk; and

FIG. 7 is a partial enlarged view of an anchoring device according to the present invention having steps of which those nearer to the rear end of the trunk have smaller widths than those nearer to the front end of the trunk.

### DETAILED DESCRIPTION OF THE PREFERRED EMBODIMENTS

Now the embodiment of this invention is described with reference to the drawings.

As shown, the anchoring device of this invention comprises an insertion member 1 made of synthetic resin, a plate nut 2 mounted to the front end of the insertion member 1, and a tubular seat member 3 inserted onto the insertion member 1.

The insertion member 1 comprises an elongated trough-shaped trunk 4 having a substantially semicircular cross-section, and a pocket 6 integrally connected to the trunk 4 through bendable portions 5. The pocket 6 is a square tubular member having a closed bottom in which the plate nut 2 is received. The pocket 6 has both sides of its open top end integrally connected to the top ends of the front end of the trough-shaped trunk 4 through the thin bendable portions 5, respectively.

The pocket 6 is formed such that the axis of its square hole 7 extends perpendicular to the longitudinal direction of the trough-shaped trunk 4, and can be pivoted upwardly about the bendable portions 5.

The plate nut 2 is a rectangular metal plate having a thickness of e.g. about 4 mm and elongated in the vertical direction. The plate nut 2 has a threaded hole 8 formed therethrough at its portion protruding from the open top end of the pocket 6 when the plate nut 2 is inserted in the pocket 6. The plate nut 2 has at its top end a bent portion 10 that is bent toward the trough-shaped trunk 4 by a distance substantially equal to the thickness of the rear wall 9 of the pocket 6, i.e. the wall of the pocket 6 provided adjacent to the trough-shaped trunk 4.

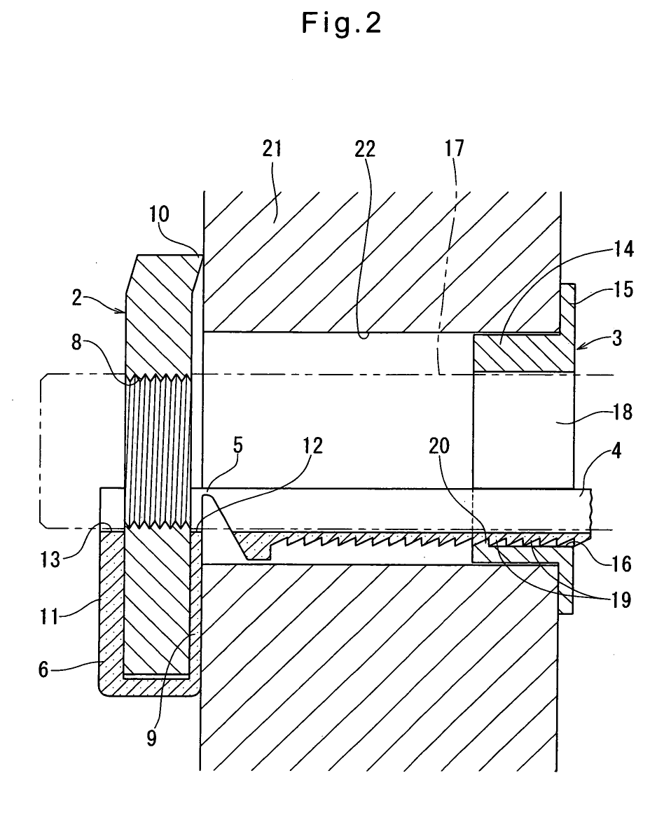

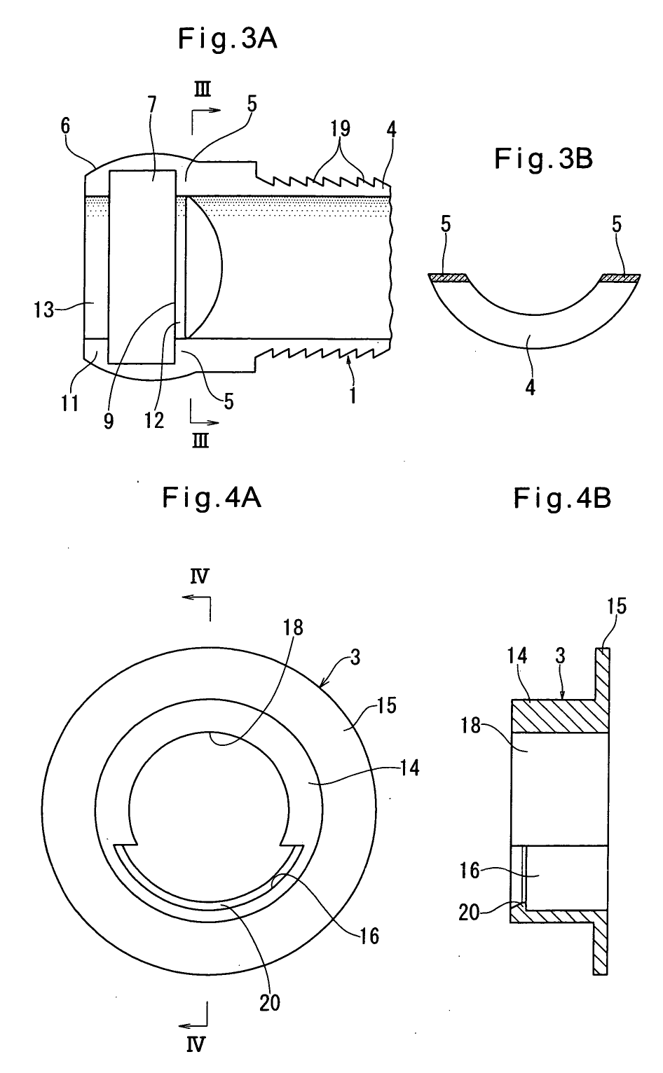

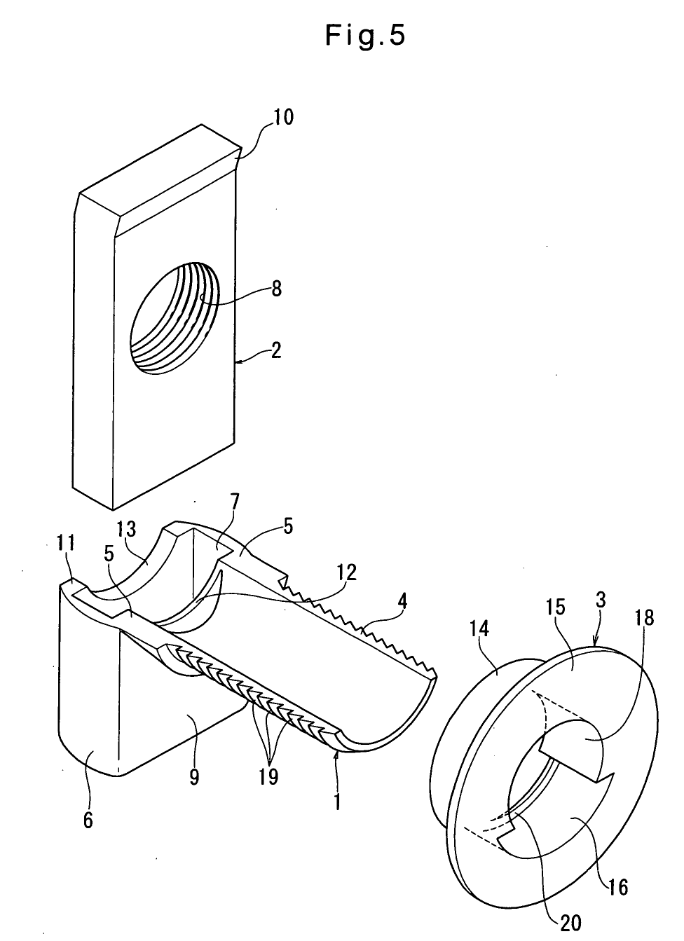

The threaded hole 8 has a diameter equal to or slightly smaller than the inner diameter of the trough-shaped trunk 4. In the state of FIG. 2, in which the plate nut 2 is inserted in the square hole 7 of the pocket 2, the trough-shaped trunk 4 is coaxial with the threaded hole 8 of the plate nut 6. The front and rear walls 11 and 9 of the pocket 6 have arcuately concave top edges 13 and 12, respectively, so as not to interfere with the threaded hole 8. The top edge 12 of the rear walls 9 is disposed adjacent to the front end of the trough-shaped trunk 4.

The seat member 3 is made of synthetic resin, and comprises a cylindrical portion 14 configured to be fitted onto the trough-shaped trunk, and a flange 15 extending radially outwardly from the rear end of the cylindrical portion 14. The cylindrical portion 14 has a radially inner surface comprising a substantially lower half portion 16 having a large diameter so as to correspond to the outer diameter of the trough-shaped trunk 4, and the remaining upper half portion 18, which has a diameter smaller than the lower half portion 16 and into which a bolt 17 is fitted. But instead, the seat member 3 may have a cross-section in the shape of a segment of a circle.

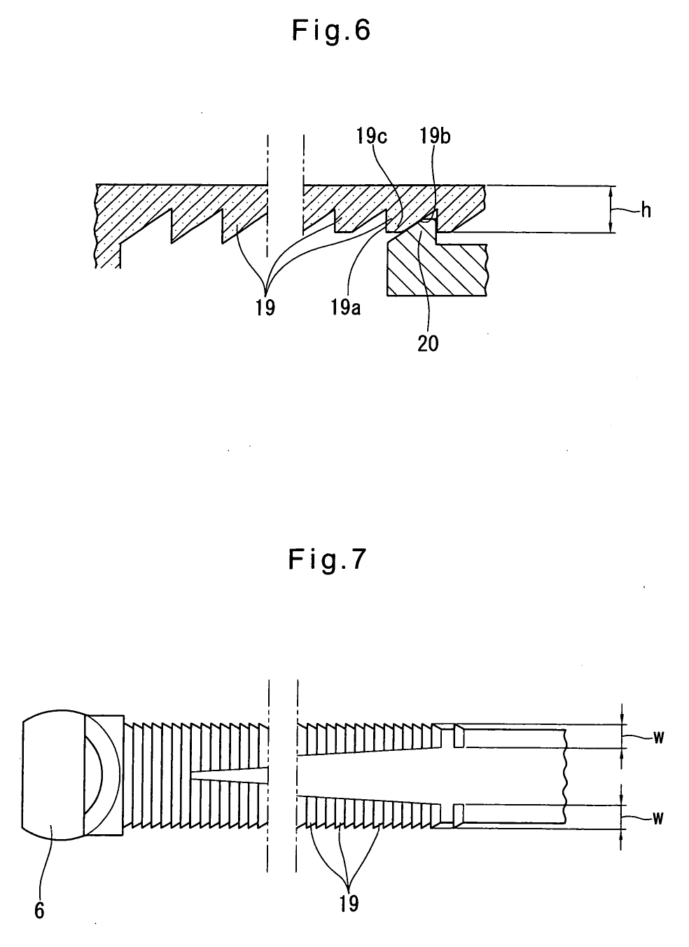

First and second retainer means are provided on the radially outer surface of the trough-shaped trunk 4 and the radially inner surface of the large-diameter portion 16 of the seat member 3, respectively, which, in cooperation with each other, allow movement of the seat member 3 toward the front end of the trough-shaped trunk 4 and prevent movement of the seat member 3 in the opposite direction relative to the trough-shaped trunk 4. The first retainer means, which is provided on the radially outer surface of the trough-shaped trunk 4, comprises, as shown e.g. in FIG. 2, a plurality of steps 19 arranged in the longitudinal direction of the trunk 4 and each having a surface 19a facing the front end of the trunk 4 and extending substantially perpendicular to the longitudinal direction of the trunk 4, and a surface 19b facing the rear end of the trunk and inclined relative to the longitudinal direction of the trunk 4. Thus, the first retainer means has a serration-shaped longitudinal section. The steps 19 may be arranged such that each step 19 is smaller than the step 19 immediately in front thereof. Alternatively, the steps 19 may be divided into a plurality of groups each comprising a plurality of adjacent steps which are smaller than the group of steps 19 immediately in front thereof. FIG. 6 shows steps 19 of which those nearer to the rear end of the trough-shaped trunk have smaller heights h than those nearer to the front end of the trunk. FIG. 7 shows steps 19 of which those nearer to the rear end of the trough-shaped trunk have smaller widths w than those nearer to the front end of the trunk.

Now description is made of how the anchoring device according to this invention is used.

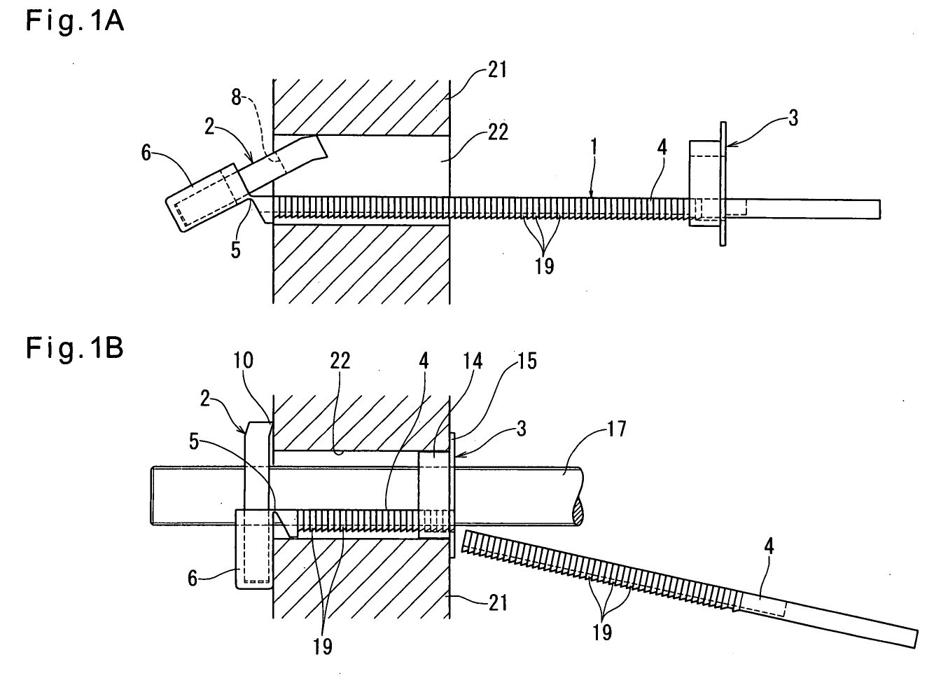

FIGS. 1A, 1B and 2 show how an object is secured to a wall member 21 of which the back is inaccessible by hand with a bolt 17. In the wall member 21, a lateral hole 22 is drilled having such a diameter that the cylindrical portion 14 of the seat member 3 can be fitted; the plate nut 2 is inserted in the pocket 6 of the insertion member 1; and the pocket 6 and the plate nut 2 are pivoted upwardly about the bendable portions 6 so that the plate nut 2 extends substantially parallel to the length direction of the trough-shaped trunk 4 and held in this position by hand.

In this state, the pocket 6 and then the trough-shaped trunk 4 are inserted into the lateral hole 22 from the front side of the wall member.

FIG. 1A shows the state in which the plate nut is still in the lateral hole 22. In this state, because the pocket 6 and the plate nut 2 are biased by the bendable portions 5, which are made of synthetic resin, toward their original position, the pocket 6 and the plate nut 2 move through the lateral hole 22 in an inclined state while being in abutment with the top surface of the lateral wall 22, without being held by hand.

When the pocket 6 and the plate nut 2 completely come out of the lateral hole 22 into the back side of the wall member 21, the pocket 6 and the plate nut 2, which are being biased by the bendable portions 5, return to the original position, so that by pulling back the trough-shaped trunk 4, the rear wall 9 of the pocket 6 and the top end of the plate nut 2 abut the back of the wall member 21, thus preventing the trough-shaped trunk 4 from being pulled out of the lateral hole 22. In this state, the threaded hole 8 of the plate nut 2 faces the lateral hole 22.

In this state, as shown in FIG. 1B, with the trough-shaped trunk 4 received in the large-diameter portion 16 of the seat member 3, the seat member 3 is advanced. When the seat member 3 advances, an engaging rib 20 formed on the radially inner surface of the seat member 3 as the second retainer means is brought into engagement with the respective serration-shaped steps 19 one after another. When the engaging rib 20 engages the respective steps 19 one after another, the engaging rib 20 inevitably becomes worn and its height decreases. But since the steps 19 nearer to the rear end of the trough-shaped trunk are smaller than the steps 19 nearer to the front end of the trunk, it is possible to minimize initial frictional resistance encountered by the engaging rib 20, which in turn minimizes the wear of the engaging rib 20. Also, even when the engaging rib 20 becomes worn and its height decreases as it advances toward the front end of the trough-shaped trunk, because the steps 19 nearer to the front end of the trunk is larger, the engaging rib 20 can stably engage the steps 19 nearer to the front end of the trunk in the same manner as the steps 19 nearer to the rear end of the trunk. If the engaging rib 20 becomes worn to a lesser extent due e.g. to the fact the seat member 3 is advanced slowly, the engaging rib 20 may engage the steps nearer to the front end of the trunk more strongly. But because the seat member is moving, a slight increase in the engaging resistance will not be an obstacle. The seat member 3 is advanced until the cylindrical portion 14 engages in the lateral hole 22.

In this state, the engaging rib 20 of the seat member 3 engages one of the steps 19 of the trough-shaped trunk 4, so that the seat member 3 is prevented from coming out of the lateral hole 22.

In this state, the portion of the trough-shaped trunk 4 protruding from the seat member 3 is broken or cut off with a knife, and the bolt 17, which is inserted through an object (not shown) to be secured to the wall member 21, is inserted through the small diameter portion 18 of the seat member 3 into the lateral hole 22, and then threaded into the threaded hole 8.

When the bolt 17 is threaded into the threaded hole 8, the bolt 17 pulls the plate nut 2 against the back of the wall member 21, while fixing the object to be secured to the wall member 21 with its head. Thus, the object to be secured can be rigidly secured to a wall member of which the back is inaccessible by hand, without accessing the back of the wall member.

What is claimed is:

1. An anchoring device comprising:
an insertion member comprising a trough-shaped trunk having a longitudinal axis and first and second longitudinal ends, and a pocket provided at said first longitudinal end of said trough-shaped trunk through a bendable portion so as to form an angle relative to said longitudinal axis of said trough-shaped trunk;
a plate nut inserted in said pocket and formed with a threaded hole at its portion protruding from the pocket;
a seat member fitted around said trough-shaped trunk; and
first and second retainer means provided on a radially outer surface of said trough-shaped trunk and a radially inner surface of said seat member, respectively, for keeping said seat member from coming off said trough-shaped trunk, said first retainer means comprising a plurality of steps arranged in the direction of said longitudinal axis of said trough-shaped trunk and having a serration-shaped longitudinal section, each of said steps comprising a surface facing said first longitudinal end and extending substantially perpendicular to said longitudinal axis of said trough-shaped trunk, and a surface facing said second longitudinal end and extending oblique to said longitudinal axis of said trough-shaped trunk, wherein any of said steps nearer to said second longitudinal end of said trough-shaped trunk is smaller than any of said steps nearer to said first longitudinal end of said trough-shaped trunk, whereby said second retainer means engages any of said steps nearer to said second longitudinal end with a smaller force.

2. An anchoring device comprising:
an insertion member comprising a trough-shaped trunk having a longitudinal axis and first and second longitudinal ends, and a pocket provided at said first longitudinal end of said trough-shaped trunk through a bendable portion so as to form an angle relative to said longitudinal axis of said trough-shaped trunk;
a plate nut inserted in said pocket and formed with a threaded hole at its portion protruding from the pocket;
a seat member fitted around said trough-shaped trunk; and
first and second retainer means provided on a radially outer surface of said trough-shaped trunk and a radially inner surface of said seat member, respectively, for keeping said seat member from coming off said trough-shaped trunk, said first retainer means comprising a plurality of steps arranged in the direction of said longitudinal axis of said trough-shaped trunk and having a serration-shaped longitudinal section, each of said steps comprising a surface facing said first longitudinal end and extending substantially perpendicular to said longitudinal axis of said trough-shaped trunk, and a surface facing said second longitudinal end and extending oblique to said longitudinal axis of said trough-shaped trunk, wherein any of said steps nearer to said second longitudinal end of said trough-shaped trunk has a smaller height than any of said steps nearer to said first longitudinal end of said trough-shaped trunk, whereby said second retainer means engages any of said steps nearer to said second longitudinal end with a smaller force.

3. An anchoring device comprising:
an insertion member comprising a trough-shaped trunk having a longitudinal axis and first and second longitudinal ends, and a pocket provided at said first longitudinal end of said trough-shaped trunk through a bendable portion so as to form an angle relative to said longitudinal axis of said trough-shaped trunk;
a plate nut inserted in said pocket and formed with a threaded hole at its portion protruding from the pocket;
a seat member fitted around said trough-shaped trunk; and
first and second retainer means provided on a radially outer surface of said trough-shaped trunk and a radially inner surface of said seat member, respectively, for keeping said seat member from coming off said trough-shaped trunk, said first retainer means comprising a plurality of steps arranged in the direction of said longitudinal axis of said trough-shaped trunk and having a serration-shaped longitudinal section, each of said steps comprising a surface facing said first longitudinal end and extending substantially perpendicular to said longitudinal axis of said trough-shaped trunk, and a surface facing said second longitudinal end and extending oblique to said longitudinal axis of said trough-shaped trunk, wherein any of said steps nearer to said second longitudinal end of said trough-shaped trunk has a smaller width than any of said steps nearer to said first longitudinal end of said trough-shaped trunk, whereby said second retainer means engages any of said steps nearer to said second longitudinal end with a smaller force.
